(19) United States
(12) Patent Application Publication
(10) Pub. No.: US 2012/0212178 A1
(43) Pub. Date: Aug. 23, 2012

(54) DEVICE, SYSTEM, AND METHOD FOR INDUCTIVE CHARGING

(75) Inventor: Jae Ki KIM, Seoul (KR)

(73) Assignee: PANTECH CO., LTD., Seoul (KR)

(21) Appl. No.: 13/289,638

(22) Filed: Nov. 4, 2011

(30) Foreign Application Priority Data
Feb. 17, 2011 (KR) 10-2011-0014187

(51) Int. Cl. H02J 7/00

(52) U.S. Cl. 320/108; 320/137

(57) ABSTRACT

In a device system, and method for inductive charging, an efficiency of transmission of electromagnetic induced power may be maximized. Specifically, a control portion of a charging device may change an attribute, such as position or area, of a primary coil as to be more aligned with a secondary coil of to be charged device.

### CROSS-REFERENCE TO RELATED APPLICATION

This application claims priority from and benefit under 35 U.S.C. §119(a) of Korean Patent Application No. 10-2011-0014187, filed on Feb. 17, 2011, which is incorporate by reference for all purposes as if fully set forth herein.

### BACKGROUND

1. Field

This disclosure relates to a device, a system, and a method for inductive charging.

2. Discussion of the Background

Mobile terminals, such as smart phones, internet telephone (IT) devices, personal digital assistants (PDA) and notebooks have become utilized at a higher frequency. Since these devices are mobile, a battery is attached thereto. The battery is charged by a charging device, with the battery being separated from the device, or the battery being attached to both the device and the charging device. An inductive or non-contact charging device has been developed. The inductive charging device wireles sly charges the battery of the mobile device using electromagnetic induction through wireless power transmitting and receiving technology.

The wireless power transmitting and receiving technology may be achieved with a primary coil installed in an inductive charging device, and a secondary coil installed at a subject charging device. The efficiency of the inductive charging device may be measured or determined with a degree of matching between the positions of the primary coil and the secondary coil. Thus, the charging efficiency may be maximized if the positions of the primary coil and the secondary coil are aligned with each other, or if the centers of the coils are aligned with each other. In order to satisfy this condition, a distinct inductive charging device for a specific subject charging terminal is provided. Thus, the inductive charging device includes a primary coil having a capacity capable of supplying a maximized amount of power to a secondary coil built in a specific subject charging device, and a fixing structure installed therein. The fixing structure fixes the position of the subject charging terminal so that the subject charging terminal aligns with the primary coil.

A general-purpose inductive charging terminal capable of charging various types of IT devices may be useful, as a user may own different types of devices or multiple users may use the same inductive charging terminal. However, the inductive charging terminal may not match a specific specification, since the capacity of the primary coil may not be configured for the secondary coil of the subject charging terminal.

### SUMMARY

This disclosure is directed to a device, a system, and a method for performing inductive charging with maximized or increased power transmission efficiency, and controlling a position and an area of a primary coil.

Additional features of the invention will be set forth in the description which follows, and in part will be apparent from the description, or may be learned by practice of the invention.

An exemplary embodiment provides an inductive charging device to supply power to a subject charging terminal, the device including: a primary coil to charge a secondary coil of the subject charging terminal through electromagnetic induction; a power supply section to supply induced current to the primary coil; and a first control section to control the supply of induced current and to change an attribute of the primary coil to maximize transmission efficiency of the electromagnetic induction.

An exemplary embodiment provides an inductive charging system, the system including: an inductive charging device to supply power to the subject charging terminal, the inductive charging device with a primary coil to produce electromagnetic induction, a power supply section to supply an induced current to the primary coil, and a first control section to control the power supply section; the subject charging terminal including: a secondary coil magnetically coupled to the primary coil and to generate an induced voltage, and a battery to receive the induced voltage, wherein the first control section changes an attribute of the primary coil to maximize transmission efficiency of the electromagnetic induction.

An exemplary embodiment provides a method for inductive charging, the method including: detecting whether a subject charging terminal is placed on an inductive charging device; applying power to a primary coil of the inductive charging device; changing an attribute of the primary coil to achieve a maximum transmission efficiency of electromagnetic induction between a secondary coil of the subject charging terminal and the primary coil; detecting an induced voltage of the secondary coil; detecting a point at which the maximum transmission efficiency is achieved; and fixing the attribute corresponding to the point.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective illustrating an inductive charging system according to an exemplary embodiment.

FIG. 2 is a diagram illustrating the inductive charging system according to an exemplary embodiment.

FIG. 3A is a schematic diagram illustrating a method for changing an area of a primary coil according to an exemplary embodiment.

FIG. 3B is a diagram illustrating a change in area of the primary coil according to an exemplary embodiment.

FIG. 4 is a schematic diagram illustrating a method for moving the position of the primary coil according to an exemplary embodiment.

FIG. 5 is a flowchart illustrating a method for inductive charging according to an exemplary embodiment.

FIG. 6 is a flowchart illustrating a method for controlling the position of the primary coil according to an exemplary embodiment.

FIG. 7 is a flowchart illustrating a method for controlling the area of the primary coil according to an exemplary embodiment.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, the disclosure will be described in detail by referring to the accompanying drawings. However, the accompanying drawings and the description below are merely an example of an inductive charging device, an inductive charging system, and an inductive charging method according to the disclosure and the technical concept of the disclosure is not limited thereto.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

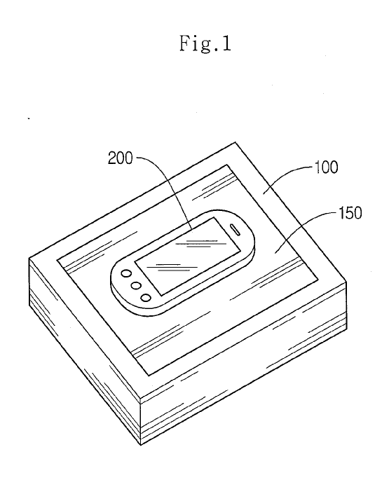

FIG. 1 is a perspective illustrating an inductive charging system according to an exemplary embodiment.

Referring to FIG. 1, the inductive charging system includes an inductive charging device 100 and a subject charging terminal 200. The inductive charging system may also include a charging station 150.

The inductive charging device 100 charges the subject charging terminal 200 by supplying power through electromagnetic induction. The charging station 150 is positioned at the top portion of the inductive charging device 100, and charges the subject charging terminal 200. The charging station 150 includes a pressure sensor and the like, and detects a contact state and contact position of the subject charging terminal 200.

The subject charging terminal 200 may include various mobile terminals with a battery or devices requiring charging. In FIG. 1, a smart phone is shown; however, the aspects described of the subject charging terminal 200 are not limited thereto.

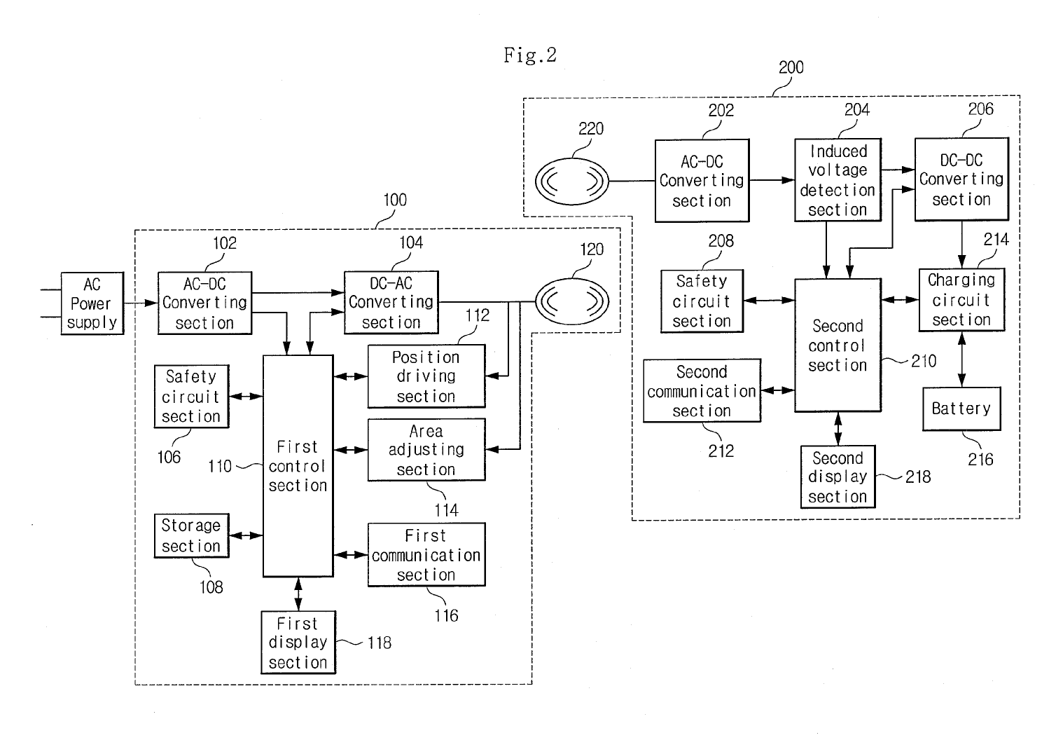

FIG. 2 is a diagram illustrating the inductive charging system according to an exemplary embodiment.

Referring to FIG. 2, the inductive charging device 100 includes an AC-DC converting section 102, a DC-AC converting section 104, a safety circuit section 106, a storage section 108, a first control section 110, a position driving section 112, an area adjusting section 114, a first communication section 116, a first display section 118, and a primary coil 120.

Referring again to FIG. 2, the subject charging terminal 200 includes an AC-DC converting section 202, an induced voltage detecting section 204, a DC-DC converting section 206, a safety circuit section 208, a second control section 210, a second communication section 212, a charging circuit section 214, a battery 216, a second display section 218, and a secondary coil 220.

The AC-DC converting section 102 receives an AC voltage from an external AC power supply and outputs a DC voltage which is transmitted to the DC-AC converting section 104, and the DC voltage is supplied to the first control section 110. The control section 110 may operate various circuits.

The DC-AC converting section 104 receives the DC voltage from the AC-DC converting section 102 and outputs an alternating current to the primary coil 120. Thus, if alternating current is supplied to the primary coil, the amount of magnetic flux changes in the primary coil, with the change generating an induced electromotive force (voltage) in the secondary coil 220.

The safety circuit section 106 monitors information representing whether there is an abnormal condition, such as a high temperature, voltage, current, and/or the like inside and associated with the inductive charging device 100. If an abnormal state is detected from the monitoring, the safety detection section 106 transmits information indicating an abnormal state to the control section 110. Thus, since a fire may occur if the temperature inside the inductive charging device 100, a current, or voltage exceeds a threshold, the safety circuit section 106 is provided to stop the charging operation, thereby preventing a fire or another unwanted event.

The storage section 108 stores a database containing various control operations of the inductive charging device 100. In particular, terminal information may be stored. The terminal information is used to verify whether the subject charging terminal 200 placed on the charging station 150 is a terminal to be charged. With this configuration, the overheating of the charging station 150 may be prevented if a metallic object is placed thereon. Further, the safety and the efficiency of the circuits in the inductive charging device 100 may be improved by supplying power to verified terminals if a subject charging terminal 200 with a battery 216 is placed on or near the associated inductive charging device 100.

The position driving section 112 moves the position of the primary coil 120, such as in the X and Y directions, based on instructions received from the first control section 110. The position driving section 122 is used to increase or maximize the charging efficiency.

The area adjusting section 114 changes the area of the primary coil 120 by controlling one or more switches installed at the primary coil 120, by turning the switches on or off. The area adjusting section 114 is also provided to maximize the charging efficiency.

The first communication section 116 transmits and receives information to and from the second communication section 212. In particular, the first communication section 116 may receive various operation information relating to the charging state, the safety state, and/or the like, of the subject charging terminal 200 via the second communication section 212.

The first display section 118 displays various operation states of the inductive charging device 100. The first display section 118 may include an LED and/or the like, and provides a user with information emitting a different color of light in accordance with the connection state of the AC power supply, the power supply state, and other elements that are connected with and used in association with the inductive charging device 100. Further, the first display section 118 may include a full display to display statistics and/or features of the inductive charging device 100.

The first control section 110 receives information on the above-mentioned circuits/elements and performs control of the overall charging operation.

The AC-DC converting section 202 converts an AC induced voltage generated in the secondary coil 220 into a DC voltage by electromagnetic induction. The DC voltage is transmitted to the various circuits, such as the second control section 210 and the DC-DC converting section 206, through the induced voltage detection section 204.

The induced voltage detecting section 204 detects the voltage output from the AC-DC converting section 202 and the DC induced voltage generated by the secondary coil 220. The DC induced voltage is used to determine whether maximized power transmission efficiency is achieved.

The DC-DC converting section 206 receives the DC voltage output from the AC-DC converting section 202 and converts it into a DC voltage suitable for charging the battery 216.

The charging circuit section 214 controls the charging operation of the battery 216 based on an instruction from the second control section 210.

The safety circuit section 208 performs an operation similar to that of the safety circuit section 106. That is, if the safety circuit section 208 detects an abnormal condition, such as a high temperature, an overvoltage, an overcurrent, and/or the like, inside or associated with the subject charging terminal 200, the safety circuit section 208 transmits an indication of an abnormal state to the second control section 210.

The second communication section 212 transmits and receives various information to and from the first communication section 116.

The second display section 218 is similar to that of the first display section 118, and thus, will not be fully described herein.

The second control section 210 receives information on the above-mentioned circuits and performs the control of the overall charging operation.

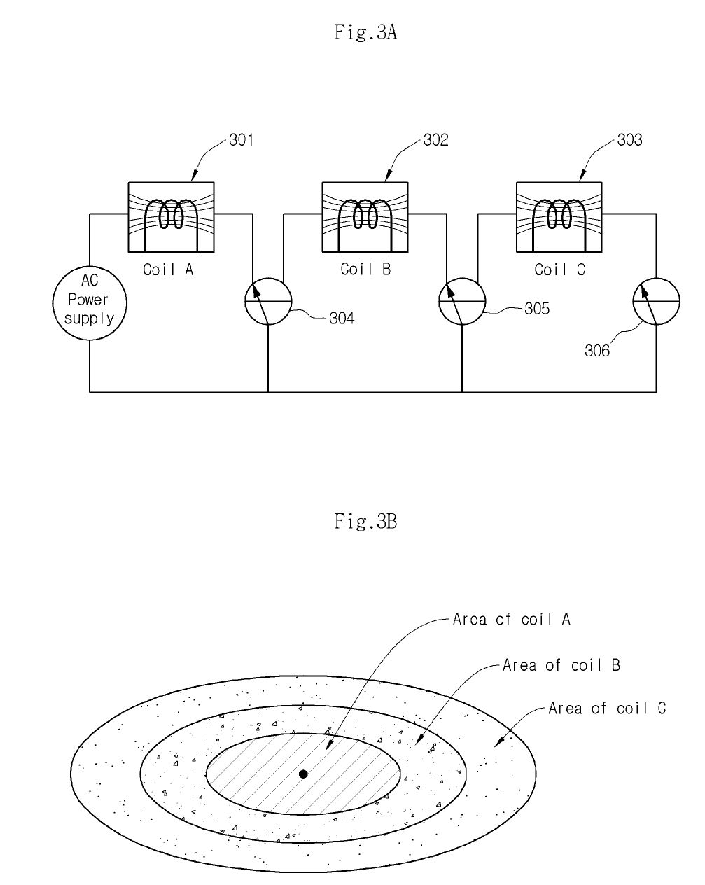

FIG. 3A is a schematic diagram illustrating a method for changing an area of a primary coil according to an exemplary embodiment. FIG. 3B is a diagram illustrating a change in area of the primary coil according to an exemplary embodiment.

The inductive charging system includes a general-purpose inductive charging device 100 used to charge a subject charging terminal 200 with varying sizes and charging capabilities from another subject charging terminal 200. The electromotive force induced in the secondary coil 220 of the inductive charging system is based on a change in the amount of magnetic flux of the primary coil 120. However, if the area of the primary coil 120 is smaller than that of the secondary coil 220, the magnetic flux generated in the primary coil 120 escapes to free space, so that the electromotive force induced to the secondary coil is not maximized.

Accordingly, the area of the primary coil 120 may be equal to or larger than that the secondary coil 220 in order to transmit the magnetic flux generated in the primary coil 120 to the secondary coil 220. However, in the case of a terminal, such as a smart phone or a tablet PC, the change of an area of the secondary coil 220 may be restricted, thereby resulting in a decrease in electromotive force. To counter this, the inducement of electromotive force may be increased by increasing the area of the primary coil 120. However, if the area of the primary coil 120 is increased too much, the resistance of the primary coil 120 may also be increased causing a large amount of heat to be generated and the power efficiency to be degraded. Thus, the areas of the primary coil 120 and the secondary coil 220 may be approximately equal to each other to maximize power efficiency and avoid an abnormal condition state.

Thus, the area of the primary coil 120 may be changed to correspond to the area of the secondary coil 220. In order to realize this, the inductive charging device 100 may have a primary coil 120 with an adjustable area.

Referring to FIG. 3A, a schematic diagram illustrating an adjustable primary coil 120 is shown. The shape of the primary coil 120 may be a wide disk shape, as shown in FIG. 3B. One or more switches may be installed at intermediate positions of the wide-disk-shaped primary coil 120, thereby connecting or disconnecting the coils from each other.

In FIGS. 3A and 3B, the primary coil 120 is separated into three regions. The primary coil 120 may be separated into coil a 301, coil b 302, and coil c 303 by three switches, 304, 305 and 306. When the switches are turned on one by one from the left side, in FIG. 3A, the area of the primary coil 120 may be increased.

A change in area of the primary coil as a result of the operation above will be described below by referring to FIG. 3B.

As shown in FIG. 3B, if the left switch 304 is turned on, the primary coil 120 has an area corresponding to the area of the coil a 301. If the middle switch 305 is turned on additional to switch 304 remaining on, the area of the primary coil 120 is widened to the area of the coil b 302. If the right switch 306 is turned on additional to switch 304 and switch 305 being on, the area of the primary coil 120 may be widened to the area of the coil c 303. The position driving section 112a and the position driving section 112b may be driven independently, and may be driven sequentially or simultaneously. An example with three coil portions and switches is disclosed herein; however, aspects are not limited herein to the number of switches and coils described.

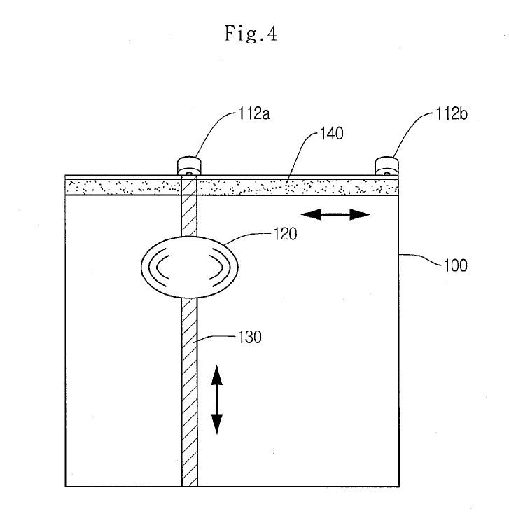

FIG. 4 is a schematic diagram illustrating a method for moving the position of the primary coil according to an exemplary embodiment.

Referring to FIG. 4, position driving sections 112a and 112b are provided to move the position of primary coil 120. The position driving section 112a may move the primary coil 120 in the Y direction by driving a Y-axis belt 130, and the position driving section 112b may move the primary coil 120 in the X direction by driving an X-axis belt 140. The position driving section 112a and the position driving section 112b may be driven independently, and may be driven sequentially or simultaneously. In FIG. 4, the primary coil 120 is described as moveable in two directions, X and Y; however, aspects of this invention are not limited to these directions.

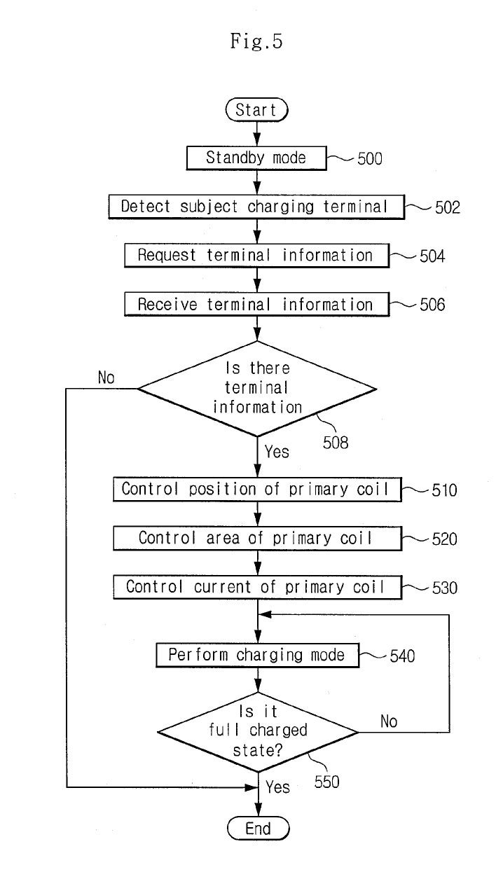

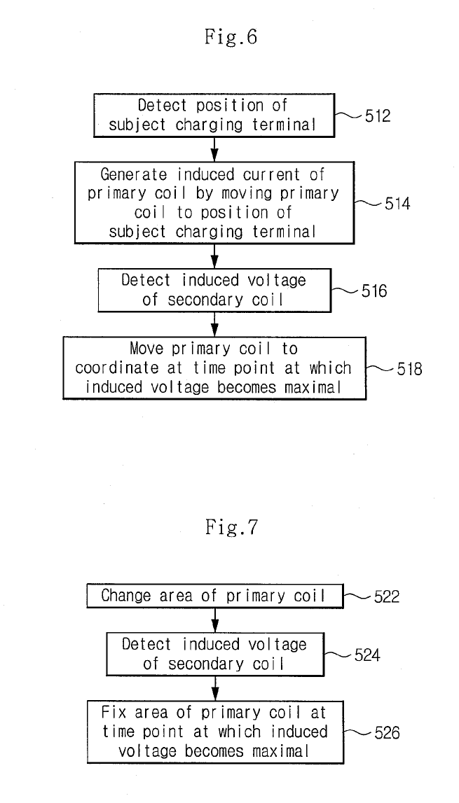

FIG. 5 is a flowchart illustrating a method for inductive charging according to an exemplary embodiment. FIG. 6 is a flowchart illustrating a method for controlling the position of the primary coil according to an exemplary embodiment. FIG. 7 is a flowchart illustrating a method for controlling the area of the primary coil according to an exemplary embodiment.

If an alternating voltage is applied from the AC power supply to the inductive charging device 100, the inductive charging device 100 enters a charging standby mode (500). The charging standby mode is a state where power may be supplied to the subject charging terminal 200 if the subject charging terminal 200 is positioned on or near the charging station 150.

If a user places the subject charging terminal 200 on or near the charging station 150, the first control section 110 detects that the subject charging terminal 200 is positioned on or near the charging station 150; thereby causing the inductive charging device to enter a contact mode (502). A sensor, such as a pressure sensor, is installed at the charging station 150, so that the charging station 150 may detect the contact state and the contact position between the subject charging terminal 200 and the charging station 150.

Although not shown in the flowchart, an operation may be further included which moves the primary coil 120 to correspond to the position of the subject charging terminal 200 if the position information of the subject charging terminal 200 is detected. The battery 216 is generally installed inside the subject charging terminal 200. Accordingly, if the position is obtained before searching for the optimal position, the operation time may be shortened. The position moved to in this step may not be the exact position, and may correspond to a substantial or approximate position in order to align the primary coil 120 with the subject charging terminal 200 for a maximized charging efficiency.

If the subject charging terminal 200 is detected in operation 502, the first control section 110 requests the terminal information of the subject charging terminal 200 by communicating to the second communication section 212 via the first communication section 116 (504).

The second control section 210 transmits terminal information of the subject charging device 200 based on the terminal information request received in operation 504, to the first communication section 116.

The first control section 110 receives the terminal information through the first communication section 116 (506), and determines whether there is terminal information matching the received terminal information in the database stored in the storage section 108 (508). That is, the subject charging terminal 200 is determined as a terminal to be charged if the matching terminal information is in the database of the storage section 108, and is determined as a terminal not to be charged if there is no matching terminal information in the database of the storage section 108. However, aspects need not be limited thereto such that the inductive charging station 100 may charge a terminal 200 for which information is not included in the database stored in the storage section 108.

If the received terminal information matches terminal information in the database, the first control section 110 controls the position driving section 112 to move the primary coil 120 to a position where maximized or improved transmission efficiency is generated (510). At this time, the position control of the primary coil 120 may be performed using the method illustrated in the flowchart of FIG. 6.

Referring to FIG. 6, the position of the subject charging terminal 200 is detected (512). This detection may be performed by a pressure sensor and the like installed at the charging station 150. If the position of the subject charging terminal 200 is detected, the first control section 110 controls the position driving section 112 to move the primary coil 120 to a position corresponding to and/or aligned with the subject charging terminal 200, after which an induced current is generated in the primary coil 120 (514). The primary coil 120 is moved by scanning the entire region in which the subject charging terminal 200 is disposed.

The first control section 110 transmits a signal requesting the magnitude information of the induced voltage of the subject charging terminal 200 through the first communication section 116. The second control section 210 receives the magnitude information of the induced voltage detected from the induced voltage detecting section 204, and transmits the magnitude information to the first communication section 116 through the second communication section 212.

Thus, based on the above, the first control section 110 is able to detect the induced voltage of the secondary coil 220 (516).

The position at which the magnitude of the induced voltage becomes maximized is detected (the primary coil 120 may be moved around to determine this position), and the primary coil 120 is moved to the coordinate corresponding to the position at which the magnitude of the induced voltage is maximized (518). This position may correspond to the point where the center positions of the primary coil 120 and the secondary coil 220 are substantially equal to or align with each other.

If the positions of the primary coil 120 and the secondary coil 220 match each other in this manner, the first control section 110 controls the area adjusting section 114 so that the area of the primary coil 120 is changed or maintained to achieve a maximized power transmission efficiency (520).

Referring to the flowchart of FIG. 7, one or more switches installed in advance at the primary coil 120 are turned on to change the area of the primary coil 120 (522). After which, the induced voltage of the secondary coil 220 is detected as described above (524).

At this time, the area of the primary coil 120 is set by choosing the switches where the induced voltage is maximized (526). In this manner, it is possible to achieve maximized power transmission efficiency based on the secondary coil 220 varying in size.

In particular, if the secondary coil 220 is larger than the primary coil 120, the power transmission efficiency is improved by increasing the area of the primary coil 120 so as to correspond to the area of the secondary coil 220. If the secondary coil 220 is smaller than the primary coil 120, power waste may be prevented by decreasing the area of the primary coil 120 so as to correspond to the size of the secondary coil 220.

Referring back to FIG. 5, if the position and the area for the primary coil 120 are determined as described above, the first control section 110 controls the magnitude of the alternating current supplied to the primary coil 120 (530). In order to transmit the charging current to the battery 216 of the subject charging terminal 200, the electromotive force induced to the secondary coil 220 may be within the input voltage range of the DC-DC voltage supply section (the DC-DC converting section 206). In order to realize this structure, the amount of the magnetic flux generated in the primary coil 120 may be increased. Since the optimal position and the optimal area of the primary coil 120 are determined and the primary coil is moved and/or resized to achieve the optimal position and optimal area, the amount of the alternating current flowing to the primary coil 120 may be increased in order to increase the amount of electromotive force induced to the secondary coil 220. However, if the amount of the current is increased too much, an abnormal or excessive heat may be generated in the primary coil 120. This may cause a device to burn, or start a fire.

The charging operation may be stopped by interrupting the supply of the alternating current to the primary coil 120 if the abnormal state is determined due to an abnormally high temperature, an overcurrent, an overvoltage, and/or the like, of the inductive charging device 100 and the subject charging terminal 200.

Further, the DC induced voltage of the secondary coil 220 may be between the minimum and the maximum of the operation input voltage of the DC-DC converting section 206. The induced voltage is generated by a change in the amount of magnetic flux flowing to the primary coil 120, and the change in the amount of magnetic flux based on the current flowing to the primary coil 120. Accordingly, the alternating input current for this condition is stored, and the current is controlled within the range of the current, so that the operation of the inductive charging system may be more stably performed.

The charging mode is performed as described above (540), and the first control section 110 determines whether the battery 216 is fully or adequately charged (550). If the battery 216 reaches the fully or adequately charged state, the charging operation is ended by interrupting the alternating current supplied to the primary coil 120. If it is not at the fully or adequately charged state, the charging operation is continuously performed (540). Furthermore, although it is not shown in the flowchart, the inductive charging system may be protected by ending the charging operation if the abnormal state of the inductive charging system is determined due to an abnormally high temperature, an overcurrent, an overvoltage, or the like.

The inductive charging device, the inductive charging system, and the inductive charging method according to the disclosure may perform the charging operation to produce maximum power transmission efficiency with respect to various subject charging terminals using various types of batteries.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An inductive charging device to supply power to a subject charging terminal, the device comprising:
a primary coil to induce a current in a secondary coil of the subject charging terminal;
a power supply section to supply a voltage to the primary coil; and
a first control section to control the supply of the voltage and to change an attribute of the primary coil to maximize transmission efficiency of the electromagnetic induction.

2. The inductive charging device according to claim 1, further comprising:
an area-adjusting section to switch an on-off state of a connection between a first portion of the primary coil and a second portion of the primary coil,
wherein the attribute is area, and the area is based on the on-off state.

3. The inductive charging device according to claim 1, further comprising:
a first communication section to transmit and to receive information with the subject charging terminal,
wherein the first control section receives magnitude information of induced voltage of the secondary coil via the first communication section.

4. The inductive charging device according to claim 3, further comprising:
a position driving section to move the position of the primary coil,
wherein the attribute is the position.

5. The inductive charging device according to claim 3,
wherein the first control section receives voltage information of a voltage supply section of the subject charging terminal, the voltage supply section supplies power to a battery of the subject charging terminal, the voltage information being received via the first communication section, and
wherein the first control section controls the supply of induced current based on the voltage information.

6. An inductive charging system, the system comprising:
an inductive charging device to supply power to the subject charging terminal,
the inductive charging device comprising:
a primary coil to induce a current,
a power supply section to supply a voltage to the primary coil, and
a first control section to control the power supply section; and
the subject charging terminal comprising:
the secondary coil magnetically coupled to the primary coil and to generate an induced voltage, and
a battery to receive the induced voltage,
wherein the first control section changes an attribute of the primary coil to maximize transmission efficiency of the electromagnetic induction.

7. The inductive charging system according to claim 6,
wherein the inductive charging device further comprises an area-adjusting section to switch an on-off state of a connection between a first portion of the primary coil and a second portion of the primary coil,
wherein the attribute is area, and the area is based on the on-off state of the connection.

8. The inductive charging system according to claim 6,
wherein the inductive charging device further comprises:
a first communication section to transmit and to receive information with the subject charging terminal;
wherein the subject charging terminal further comprises:
an induced voltage detecting section to detect information about an amount of the induced voltage of the secondary coil, and
a second communication section to transmit and to receive information with the inductive charging device;
wherein the second communication section transmits the information about the amount of the induced voltage to the first communication section; and
wherein the first control section determines a point at which the maximal transmission efficiency of the electromagnetic induction is achieved based on the transmitted information about the amount of the induced voltage, and the attribute is the point.

9. The inductive charging system according to claim 8,
wherein the inductive charging device further comprises a position driving section to move the position of the primary coil,
wherein the attribute is the position.

10. The inductive charging system according to claim 8,
wherein the subject charging terminal further comprises:
a voltage supply section to supply the induced voltage to a battery,
a charging circuit section to control a charging to the battery by controlling the supply of the induced voltage from the voltage supply section, and
a second control section to control the charging circuit section;
wherein the second control section transmits voltage information of the voltage supply section to the first communication section via the second communication section; and
wherein the first control section controls the power supply section based on the received voltage information.

11. A method for inductive charging, the method comprising:
detecting whether a subject charging terminal is placed on an inductive charging device;
applying power to a primary coil of the inductive charging device;
changing an attribute of the primary coil to achieve a maximum transmission efficiency of electromagnetic induction between a secondary coil of the subject charging terminal and the primary coil;
detecting an induced voltage of the secondary coil;
detecting a point at which the maximum transmission efficiency is achieved; and
fixing the attribute corresponding to the point.

12. The inductive charging method according to claim 11, further comprising:
requesting terminal information of the subject charging terminal;
receiving the requested terminal information;
determining whether the received terminal information matches a stored terminal information; and
applying power to the primary coil based on the determination.

13. The inductive charging method according to claim 11, further comprising:
switching an on-off state of a connection between a first portion of the primary coil and a second portion of the primary coil,
wherein the attribute is the area, and the area is based on the on-off state of the connection.

14. The inductive charging method according to claim 11, further comprising:
moving a position of the primary coil,
wherein the attribute is the position.

15. The inductive charging method according to claim 11,
wherein the attribute is at least one of: a position of the primary coil and an area of the primary coil.

16. The inductive charging method according to claim 11, wherein the applying of the power is based on voltage information of a voltage supply of the subject charging terminal.

17. The inductive charging device according to claim 1, further comprising:
a safety condition section to stop the power supply section based on an abnormal condition.

18. The inductive charging system according to claim 6, further comprising
a safety condition section to stop the power supply section based on an abnormal condition.

19. The inductive charging method according to claim 11, further comprising:
stopping the application of power to the primary coil based an abnormal condition.

20. The inductive charging method according to claim 11, further comprising:
moving the primary coil to an approximate position of the secondary coil.
